(19) United States
(12) Patent Application Publication
(10) Pub. No.: US 2020/0125722 A1
(43) Pub. Date: Apr. 23, 2020

(54) SYSTEMS AND METHODS FOR PREVENTING RUNAWAY EXECUTION OF ARTIFICIAL INTELLIGENCE-BASED PROGRAMS

(71) Applicant: Denso International America, Inc., Southfield, MI (US)

(72) Inventors: Gopalakrishnan Iyer, Santa Clara, CA (US); Ameer Kashani, Southfield, MI (US)

(21) Appl. No.: 16/163,936

(22) Filed: Oct. 18, 2018

(51) Int. Cl. G06F 21/54; G06F 11/30; G06F 11/07

(52) U.S. Cl. CPC G06F 21/54; G06F 11/0757; G06F 11/302

(57) ABSTRACT

System, methods, and other embodiments described herein relate to managing execution of an artificial intelligence (AI) program. In one embodiment, a method includes supervising execution of the AI program to identify execution states associated with the AI program indicative of at least current predictions produced by the AI program. The method includes activating a control binary to cause the AI program to cease execution when the execution states satisfy a kill switch threshold. The kill switch threshold defines conditions associated with the execution of the AI program indicative of adverse operating conditions.

### TECHNICAL FIELD

The subject matter described herein relates in general to systems and methods for improving the management of artificial intelligence (AI) programs, and, in particular, to supervising the execution of AI programs to prevent adverse operating conditions.

### BACKGROUND

Artificial intelligence represents a significant advancement in approaches to electronic processing capabilities. For example, the ability of a computing system to perceive aspects of an environment or data, and make intelligent determinations therefrom is a potentially powerful tool in regards to many different applications. Additionally, artificial intelligence programs may be implemented in many different forms such as probabilistic methods such as Bayesian networks, Hidden Markov models, Kalman filters, statistical methods such as neural networks, support vector machines, and so on. Whichever approach is undertaken, the developed electronic computing systems generally share a commonality in being non-deterministic and complex, and thus difficult to predict or otherwise guarantee performance within defined guidelines and functional safety standards.

Ensuring that an AI program conforms to various standards in relation to, for example, security, performance, safety, and so on can be a significant difficulty especially when a program is self-learning and/or otherwise operating autonomously to perform various functions. The functionality of AI programs is often tied to the quality of data used in the “training phase” of such systems. Over time and with enough data fed into the “learning” process of AI based systems, the execution and functionality comes closer to or can become better than desired standards and outcomes. A key difficulty in predicting the output of AI programs in a deterministic fashion is that a small amount of “bad” or incorrect data, fed into the learning mechanism of the AI program, can result in large and unknown deviations in the output of the program. Under such circumstances, the understanding of the AI program is, for example, developed within abstract internal nodes, latent spaces, and/or other models/mechanisms, which are dynamically evolving as the AI program operates and develops further understanding.

As such, ensuring the operation of the AI program within certain constraints especially in relation to functional safety standards can represent a unique difficulty because of the abstract form and autonomous nature of the AI program. Moreover, as AI programs progress in complexity and abilities, the likelihood of an AI program with runaway functionality that is outside of prescribed bounds increases. Consequently, the functionality provided by the AI program may not function as desired at all times leading to difficulties such as security holes, faults, safety hazards, and so on.

### SUMMARY

In one embodiment, example systems and methods associated with managing execution of an AI program are disclosed. As previously noted, ensuring that the execution of an AI program remains within defined constraints for purposes of security, safety, performance, and so on can represent a difficult task. That is, because the AI program executes autonomously according to developed understandings retained in abstract forms within the AI program, ensuring that actions taken by the AI program will conform to various constraints (e.g., functional safety constraints) can be difficult.

Therefore, in one embodiment, a supervisory control system is disclosed that actively monitors execution states of the AI program and ceases execution of the AI program upon the occurrence of adverse operating conditions. For example, in one approach, the disclosed supervisory control system initially injects a control binary into the AI program. The control binary is, in one embodiment, executable binary code (e.g., machine code) that is embedded within the AI program. In various approaches, the control binary may perform one or more functions including monitoring or facilitating monitoring, halting execution of the AI program, executing failover functions, and so on.

Consider that the AI program generally executes to provide functionality such as vehicle controls, object detection, path planning, object identification, and so on. Thus, within the context of a vehicle and the noted functions, if the AI program begins to execute in a runaway manner (e.g., outside of intended constraints), then the potential for harm to persons or objects may ensue. Moreover, if the AI program includes mechanisms to prevent security intrusions or other manipulation, then halting the execution of the AI program via external approaches may be difficult especially if the AI program actively adapts or includes countermeasures to prevent such actions.

Thus, if the AI program is providing controls based on sensor inputs to direct the vehicle, and begins to operate erratically by providing the controls in a manner that is inconsistent (e.g., opposing controls at successive time steps) or in a manner that is likely to result in a crash (e.g., directing the vehicle off of the road), then the supervisory control system activates the control binary to cease execution of the AI program. Because the AI program may learn and develop an internalized understanding over time about a particular task, identifying a cause of adverse operating conditions may be difficult. Thus, the supervisory control system monitors for indicators of the adverse operating conditions such as particular execution states of the AI program. In one embodiment, the supervisory control system monitors the execution states of the AI program to detect when the AI program is evolving toward or is otherwise likely to enter an adverse operating condition.

In one approach, the supervisory control system monitors internal states/values, predictions provided as outputs, statistical trends in the input/internal/output values, and other aspects (e.g., inputs) that affect the AI program or may otherwise be indicative of a present condition of the AI program. For example, the supervisory control system may monitor the noted aspects for values that are outside of a defined acceptable range, for significant changes (e.g., changes greater than a certain magnitude or of a particular character), for values that are consistently trending in a particular direction that is antithetical to defined ranges/trends, for values associated with known adverse conditions, and so on.

Moreover, the supervisory control system, in one or more embodiments, monitors the execution states for the noted conditions remotely, through information provided via a communication channel, locally through policies defined in the control binary, and/or a combination of the two. In either case, because the control binary is integrated with the AI program, the AI program cannot, for example, act to thwart the control binary from halting execution of the AI program. Thus, upon the detection of the adverse operating conditions (e.g., detected execution states satisfy a kill switch threshold), the supervisory control system activates the control binary to halt execution of the AI program. In one embodiment, the control binary can provide a kill switch for redirecting the program flow of the AI program and thereby halting execution through avoiding execution of further instructions of the AI program. In alternative approaches, the control binary functions to reset a device on which the AI program is executing or otherwise thwart further operation of the AI program. In either case, the supervisory control system improves the ability of associated systems to manage AI programs to avoid adverse operating conditions and thereby improve overall functionality through the reliable integration of improved computational processing provided by the AI programs.

In one embodiment, a supervisory control system for managing execution of an artificial intelligence (AI) program is disclosed. The supervisory control system includes one or more processors and a memory that is communicably coupled to the one or more processors. The memory stores a watchdog module including instructions that when executed by the one or more processors cause the one or more processors to supervise execution of the AI program to identify execution states associated with the AI program indicative of at least current predictions produced by the AI program. The watchdog module includes instructions to activate a control binary to cause the AI program to cease execution when the execution states satisfy a kill switch threshold. The kill switch threshold defines conditions associated with the execution of the AI program indicative of adverse operating conditions.

In one embodiment, a non-transitory computer-readable medium for managing execution of an artificial intelligence (AI) program is disclosed. The computer-readable medium stores instructions that when executed by one or more processors cause the one or more processors to perform the disclosed functions. The instructions include instructions to supervise execution of the AI program to identify execution states associated with the AI program indicative of at least current predictions produced by the AI program. The instructions include instructions to activate a control binary to cause the AI program to cease execution when the execution states satisfy a kill switch threshold. The kill switch threshold defines conditions associated with the execution of the AI program indicative of adverse operating conditions.

In one embodiment, a method of managing execution of an artificial intelligence (AI) program is disclosed. The method includes supervising execution of the AI program to identify execution states associated with the AI program indicative of at least current predictions produced by the AI program. The method includes activating a control binary to cause the AI program to cease execution when the execution states satisfy a kill switch threshold. The kill switch threshold defines conditions associated with the execution of the AI program indicative of adverse operating conditions.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a supervisory control system that is associated with managing execution of an AI program.

FIG. 2 illustrates one example of a control binary embodied within an AI program.

FIG. 3 illustrates one embodiment of a method associated with automatically halting execution of an AI program using a control binary.

FIG. 4 illustrates one embodiment of a method associated with dynamically injecting a control binary into an AI program.

### DETAILED DESCRIPTION

Systems, methods and other embodiments associated with managing execution of an AI program are disclosed. Ensuring that the execution of an artificial intelligence-based program is safe and secure can represent a difficult task. Because the AI-based program executes according to learned understandings that are generally retained within the AI program in abstract forms, precisely understanding how the AI program functions and thus whether actions of the AI program will conform to various constraints (e.g., functional safety constraints) can be difficult.

Therefore, in one embodiment, a supervisory control system actively monitors the execution of the AI program and ceases the execution upon the detection of adverse operating conditions or indicators defining the potential onset of the adverse operating conditions. For example, in one approach, the disclosed supervisory control system initially injects a control binary into the AI program. The control binary is, in one embodiment, executable binary code (e.g., machine code) that is embedded within the AI program. The supervisory control system injects the control binary into the firmware that forms the AI program such that the control binary is obfuscated by the code of the AI program. In various approaches, the control binary may perform one or more functions including monitoring the AI program, halting execution of the AI program, executing failover functions, and so on. In any case, the control binary provides the supervisory control system with a mechanism for controlling the AI program in the event that the AI program begins operating in a manner that is not desirable.

Consider an exemplary AI program that generally executes within the context of a vehicle to provide functionality such as vehicle controls, object detection, path planning, object identification, and so on. Thus, within the context of a vehicle and the noted functions, if the AI program begins to execute in a runaway manner (e.g., outside of intended constraints), then potential for harm to persons or objects may ensue. Moreover, if the AI program includes mechanisms to prevent security intrusions or other manipulation, then halting the execution of the AI program via external approaches may be difficult especially if the AI program actively adapts to prevent such actions.

Thus, if the AI program is providing controls based on sensor inputs to direct the vehicle, and begins to operate erratically by providing the controls in a manner that is inconsistent (e.g., opposing controls at successive time steps) or in a manner that is likely to result in a crash (e.g., directing the vehicle off of the road), then the supervisory control system activates the control binary to cease execution of the AI program. Because the AI program may learn and develop an internalized understanding over time about a particular task, identifying a cause of adverse operating conditions may be difficult. Thus, the supervisory control system monitors for indicators of the adverse operating conditions such as particular execution states of the AI program. In one embodiment, the supervisory control system monitors the execution states of the AI program to detect when the AI program is evolving toward or is otherwise likely to enter an adverse operating condition.

In one approach, the supervisory control system monitors internal states/values, predictions provided as outputs, statistical trends in the noted values, and other aspects (e.g., inputs) that affect the AI program or may otherwise be indicative of a present condition of the AI program. For example, the supervisory control system may monitor the noted aspects for values that are outside of a defined acceptable range, for significant changes (e.g., changes greater than a certain magnitude or of a particular character), for values that are trending in a particular direction that is antithetical to defined ranges/trends, for values associated with known adverse conditions, and so on.

Moreover, the supervisory control system, in one or more embodiments, monitors the execution states for the noted conditions remotely through information provided via a communication channel, locally through policies defined in the control binary, and/or a combination of the two. In either case, because the control binary is integrated with the AI program, the AI program cannot act to thwart the control binary from halting execution of the AI program. Thus, upon the detection of the adverse operating conditions, the supervisory control system leverages the attributes of the control binary to halt execution of the AI program. In one embodiment, the control binary can provide a kill switch for redirecting the program flow of the AI program and thereby halting execution through avoiding further instructions of the AI program from executing. In alternative approaches, the control binary functions to reset a device on which the AI program is executing or otherwise thwart further operation of the AI program. In either case, the supervisory control system improves the ability of associated systems to manage AI programs by avoiding adverse operating conditions and thereby improves overall functionality through the reliable integration of improved computational processing provided by the AI programs.

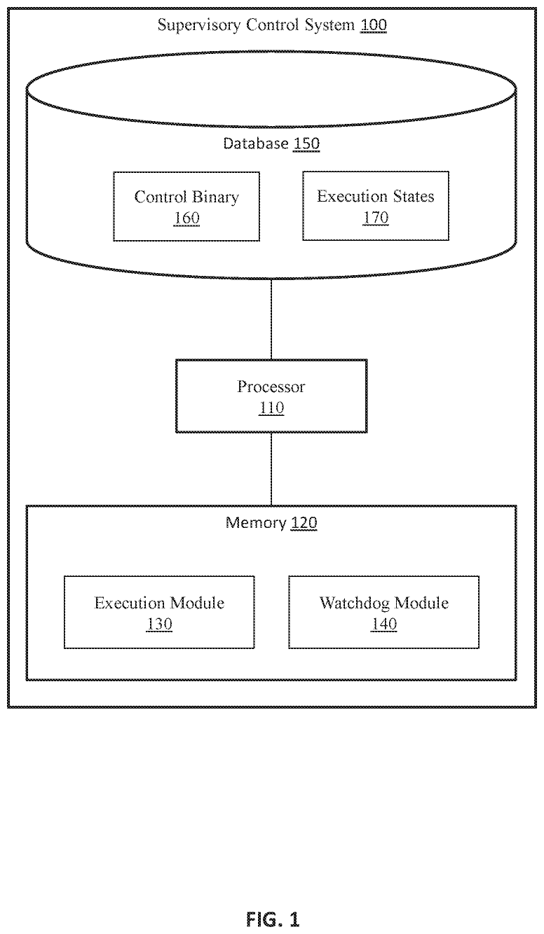

Referring to FIG. 1, one embodiment of a supervisory control system 100 is illustrated. While arrangements will be described herein with respect to the supervisory control system 100, it will be understood that embodiments are not limited to a unitary system as illustrated. In some implementations, the supervisory control system 100 may be embodied as a cloud-computing system, a cluster-computing system, a distributed computing system, a software-as-a-service (SaaS) system, and so on. Accordingly, the supervisory control system 100 is illustrated and discussed as a single device for purposes of discussion but should not be interpreted as limiting the overall possible configurations in which the disclosed components may be configured. For example, the separate modules, memories, databases, and so on may be distributed among various computing systems in varying combinations.

The supervisory control system 100 also includes various elements. It will be understood that in various embodiments it may not be necessary for the supervisory control system 100 to have all of the elements shown in FIG. 1. The supervisory control system 100 can have any combination of the various elements shown in FIG. 1. Further, the supervisory control system 100 can have additional elements to those shown in FIG. 1. In some arrangements, the supervisory control system 100 may be implemented without one or more of the elements shown in FIG. 1. Further, while the various elements are shown as being located within the supervisory control system 100 in FIG. 1, it will be understood that one or more of these elements can be located external to the supervisory control system 100. Further, the elements shown may be physically separated by large distances.

Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

In either case, the supervisory control system 100 is implemented to perform methods and other functions as disclosed herein relating to improving the execution of artificial intelligence-based programs by handling potentially adverse operating conditions. The noted functions and methods will become more apparent with a further discussion of the figures. Furthermore, the supervisory control system 100 is shown as including a processor 110. Thus, in various implementations, the processor 110 may be a part of the supervisory control system 100, the supervisory control system 100 may access the processor 110 through a data bus or another communication pathway, the processor 110 may be a remote computing resource accessible by the supervisory control system 100, and so on. In either case, the processor 110 is an electronic device such as a microprocessor, an ASIC, a graphics processing unit (GPU), an electronic control unit (ECU), or another computing component that is capable of executing machine-readable instructions to produce various electronic outputs therefrom that may be used to control or cause the control of other electronic devices.

In one embodiment, the supervisory control system 100 includes a memory 120 that stores an execution module 130, and a watchdog module 140. The memory 120 is a random-access memory (RAM), read-only memory (ROM), a hard-disk drive, a flash memory, or other suitable memory for storing the modules 130, and 140. The modules 130, and 140 are, for example, computer-readable instructions that when executed by the processor 110 cause the processor 110 to perform the various functions disclosed herein. In various embodiments, the modules 130, and 140 can be implemented in different forms that can include but are not limited to hardware logic, an ASIC, a graphics processing unit (GPU), components of the processor 110, instructions embedded within an electronic memory or secondary program (e.g., control binary 160), and so on.

With continued reference to the supervisory control system 100, in one embodiment, the system 100 includes a database 150. The database 150 is, in one embodiment, an electronic data structure stored in the memory 120, a distributed memory, a cloud-based memory, or another data store and that is configured with routines that can be executed by the processor 110 for analyzing stored data, providing stored data, organizing stored data, and so on. Thus, in one embodiment, the database 150 stores data used by the modules 130, and 140 in executing various determinations. In one embodiment, the database 150 stores a control binary 160, execution states 170, and/or other data that may be used by the modules 130, and 140 in executing the disclosed functions.

As used herein, the term “program” refers to compiled machine code that is derived from, for example, source code. Thus, the AI program is, in one embodiment, a compiled program or portion thereof that is machine code. The phrase “machine code” as used herein generally refers to a program that is represented in machine language instructions that can be, for example, executed by a microprocessor such as the processor 110, an ECU, or other processing unit. Moreover, the machine code is generally understood to be a primitive or hardware-dependent language that is comprised of opcodes (e.g., no-op instruction) defined by an instruction set implemented by associated hardware. Furthermore, the machine code itself is further comprised of data values, register addresses, memory addresses, and so on. Of course, while the program is discussed as being machine code, in further embodiments, the program is assembly code or another intermediate representation of the source code. As further used herein, binary, binary code, and other such similar phrases generally refer to machine code.

In one embodiment, the AI program is an individual program or set of programs that implements machine intelligence to achieve one or more tasks according to electronic inputs in the form of environmental perceptions or other electronic data. In various embodiments, the AI program functions according to probabilistic methods such as Bayesian networks, Hidden Markov models, Kalman filters, and so on. In further aspects, the AI program is implemented according to statistical methods such as neural networks, support vector machines, machine learning algorithms, and so on. Of course, in further implementations, the AI program may be formed from a combination of the noted approaches and/or multiple ones of the same approach. In either case, the AI program is generally defined by an ability to learn (either supervised or unsupervised) about a given task through developing an internal understanding that is embodied in the form of nodal weights, abstract latent spaces, developed parametrizations, or other suitable knowledge capturing electronic mechanisms. Moreover, the AI program generally functions autonomously (i.e., without manual user inputs) to perform the computational tasks and provide the desired outputs.

Furthermore, the AI program is organized as a set of functions and data structures that execute together to achieve the noted functions. Thus, the AI program, in one or more approaches, executes to develop the internal understanding over multiple iterations of execution from which the noted outputs are improved and provided. Thus, it should be appreciated that the AI program evolves over the successive iterations to improve/vary the internal understanding. Accordingly, because of the nature of the AI program operating as, in one sense, a black-box of which the internal understanding/configuration may not be immediately apparent, the AI program can be difficult to precisely predict/control. Moreover, at times, the AI program may develop unexpected/undesirable operating conditions that may be considered adverse. That is, for example, the AI program may develop internal understandings that result in outputs that are outside of a desirable range. As one example, the AI program may cause the vehicle to unexpectedly brake for no apparent reason. This output may occur due to an aberration in the learning process that, for example, associates some non-threatening ambient aspect with the provided braking control. Thus, while generally considered to be infrequent, such aberrations can arise and represent a potentially significant safety hazard. Additionally, while the AI program is discussed as executing on a computing system that is separate from the system 100, in one or more embodiments, the AI program and the system 100 may be co-located and/or share the same processing resources.

Continuing with FIG. 1, the database 150 includes the control binary 160 and the execution states 170. The control binary 160 is, in one embodiment, executable machine code that includes functions to monitor the AI program, halt execution of the AI program, and to provide failover functionality. Of course, in various embodiments, the control binary 160 includes instructions to halt the execution of the AI program while the other noted functions (e.g., monitoring, failover, etc.) may be provided for otherwise. In one embodiment, the control binary 160 halts execution of the AI program by interjecting within a program flow of the AI program to redirect the execution to a failover function (e.g., recovery function) or another set of instructions that cause the AI program to cease execution. In general, the control binary 160 interjects within the program flow by altering a program counter to jump to a designated section in a sequence of instructions that correspond with the control binary 160. Thus, the control binary 160 may function to alter a register or other memory location associated with a program counter or other control flow data argument that controls which instructions are executed.

The failover functions provided by the control binary 160 can include a wide variety of functions and are generally implementation specific. That is, for example, where the AI program is implemented as part of a vehicle, the failover functions may provide warnings to a driver, or execute an automatic pullover maneuver to ensure the safety of the passengers. Similarly, in further implementations, the control binary 160 implements failover functions that are context appropriate.

In either case, the control binary 160 is generally developed to be platform specific. For example, the control binary 160 is generated according to particular instruction sets such as x86, x86_64, ARM32, ARM64, and so on. In general, the noted instructions sets are defined according to different opcodes, and thus the control binary 160 is comprised of machine code that is particular to the noted instruction set.

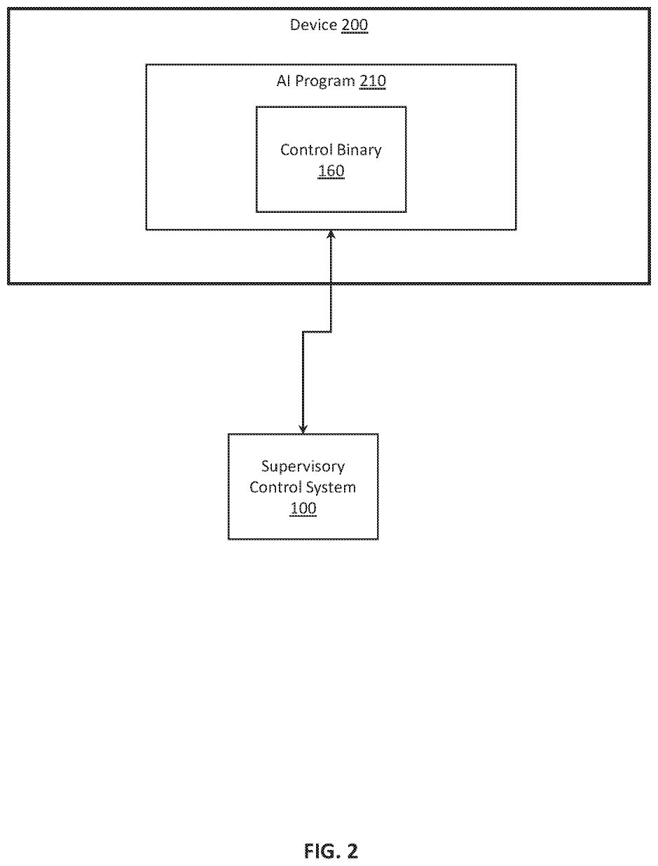

As further explanation consider FIG. 2, which illustrates an exemplary device 200 that is executing the AI program 210. The control binary 160 is illustrated as a sub-component of the AI program 210. In general, the execution module 130, which will be discussed in greater detail subsequently, injects the control binary 160 into the AI program 210 such that the control binary 160 is integrated within the AI program 210 and the memory in which the AI program 210 is stored such that the control binary 160 is indistinguishable from the AI program 210. Thus, the control binary 160 is effectively obfuscated within the AI program 210.

Moreover, the control binary 160, in one embodiment, provides monitoring functionality by either actively monitoring the execution states of the AI program 210 or by providing a mechanism through which the supervisory control system 100 monitors the execution states. For example, the control binary 160 can be configured with functionality that actively monitors the execution states of the AI program 210. In one approach, the control binary 160 sniffs or otherwise passively acquires the executions states internally from the AI program 210.

In further aspects, the control binary 160 communicates the execution states externally to the supervisory control system 100 using, for example, an application program interface (API), designated register, memory location, communication data link, or other suitable means. In either regard, the execution states of the AI program 210 are made available in order to permit monitoring.

In one embodiment, the execution states 170 include internal states/values of the AI program, predictions provided as outputs of the AI program, statistical trends in the noted values, inputs to the AI program, characteristics of internal data structures representing learned understandings of the AI program, or data that is otherwise indicative of a present condition of the AI program. For example, the execution states 170 can include additional information such as defined policies and/or metrics in relation to the actual execution states. Thus, in one approach, the additional information defines values that are outside of a defined acceptable range for the execution states, metrics associated with identifying significant changes (e.g., changes greater than a certain magnitude or of a particular character) that are indicative of potential adverse operation conditions, metrics associated with identifying values that are consistently trending in a particular direction that is antithetical to defined ranges/trends, metrics associated with identifying values known to correlate with adverse conditions, and so on. In one embodiment, the noted information that specifies adverse operating conditions of the executions states is referred to as the kill switch threshold.

Accordingly, in one embodiment, the execution module 130 includes instructions that function to inject the control binary 160 into the AI program. As previously specified in relation to FIG. 2, the control binary 160 is integrated with binary code of the AI program in a manner (e.g., randomized location) that integrates the control binary 160 as a part of the AI program. Thus, in one approach, the execution module 130 injects the control binary 160 into the AI program by appending the control binary 160 to the AI program and thus integrating the control binary 160 as part of the AI program. In further aspects, the execution module 130 modifies one or more aspects of the AI program in order to integrate the control binary 160. For example, the execution module 130 may adjust values associated with static memory values relating to an order of stored instructions and/or other aspects that may need adjustment to account for integration of the control binary 160. In either case, the execution module 130 generally functions to inject the control binary 160 as a preliminary step to configuring the AI program to be initially executed. Thus, the control binary 160 is included within the AI program as a precondition to being loaded within a system that is to implement the AI program. Of course, while discussed as a preliminary modification of the AI program, in further aspects, the supervisory control system 100 functions to adapt existing systems to include the control binary 160.

In an alternative embodiment, the execution module 130 functions to dynamically inject the control binary 160 into the AI program. That is, the execution module 130 interrupts a program flow of the AI program and causes the control binary 160 to be executed in place of the AI program. Thus, when dynamically injecting the control binary 160, the execution module 130 functions at the control of the watchdog module 140 in response to the module 140 identifying adverse operating conditions among the execution states of the AI program. Thus, the execution module 130 manipulates a program flow of the AI program to cause a next instruction that is executed to be of the control binary 160 from which the control binary 160 takes over control from the Ai program. The execution module 130 manipulates the control flow, in one embodiment, by altering memory locations associated with a program counter or other control flow data arguments. Thus, the execution module 130 is able to effectively halt execution of the AI program by redirecting execution to the control binary 160.

As such, the watchdog module 140, in one embodiment, includes instructions that function to supervise the execution of the AI program. In general, the watchdog module 140 monitors the noted execution states 170 of the AI program for conditions indicative of the adverse operating conditions. As previously mentioned, the adverse operating conditions are defined according to combinations of internal states of the AI program that are likely to produce adverse outcomes. Thus, the watchdog module 140 receives indicators of the execution states 170 from the control binary 160. For example, in one embodiment, the watchdog module 140 accesses the execution states (e.g., internal values, inputs, outputs, memory address, etc.), through an API, through the control binary 160 itself, or other suitable means. The execution states 170 of the AI program, in one embodiment, refers to values of variables that change as the AI program executes, internal configurations of data structures (e.g., nodes) and associated stored data (e.g., nodal weights, characteristics of latent spaces, parameterizations, etc.). Thus, in one embodiment, the watchdog module 140 monitors the execution states for combinations of input values, output values, internally derived and stored values representing learned understandings, and so on.

It should be appreciated that the values forming the monitored execution states may vary according to a particular implementation but generally include any combination of values associated with the execution of the AI program that are indicative of current conditions including adverse operating conditions. The adverse operating conditions and the execution states leading to the adverse operating conditions may be originally identified in order to define the values for monitoring using different approaches. For example, the adverse operating conditions may be defined according to a functional safety standard, according to known output values that are undesirable, according to predicted combinations, and so on. Moreover, the adverse operating conditions may be used to perform a regression and determine the particular execution states that lead to the adverse operating conditions. In one approach, the system 100 determines the adverse operating conditions and associated execution states according to a fault tree analysis, an analysis of a control flow graph, or another suitable approach. Whichever approach or combination of approaches may be undertaken, the supervisory control system 100 stores indicators from which the execution states are defined in order to facilitate the monitoring.

Accordingly, the watchdog module 140, in one embodiment, compares the acquired execution states with a kill switch threshold to determine whether an adverse operating condition is occurring or likely to occur. It should be noted, that the execution states, in one or more occurrences, may be indicative of an ongoing adverse operating condition or an operating condition that is characterized as imminent or likely to occur. Thus, the particular adverse operating conditions may not yet be occurring when the watchdog module 140 determines that the control binary 160 is to be activated, yet the impending nature of such an adverse operating condition and/or the character of the information identifying the adverse operating condition may not lend to waiting until the particular adverse operating condition actually develops. In either case, the watchdog module 140 accesses the values that form the execution states of the AI program via the control binary 160 or other related mechanisms (e.g., memory access provided via the control binary 160) that provide the information to the watchdog module 140.

The watchdog module 140 then compares the values that form the execution states at, for example, each execution cycle with the defined execution states 170 and/or metrics defining ranges of execution states. That is, in one aspect, the watchdog module 140 also compares the values from at least the instrumented program 180 with a map of possible ranges for the values to determine whether the values correlate with the adverse operating conditions. That is, for example, the watchdog module 140 and/or the execution module 130 determine ranges of values for the different execution states according to, for example, a history of logged values. Using this history, the watchdog module 140 analyzes the values to determine whether or not the values fall within the range. While the watchdog module 140 is generally discussed as performing the supervision of the AI program from within the supervisory control system 100, in one embodiment, the watchdog module 140 or a portion thereof is integrated with the control binary 160 within the AI program. Thus, the watchdog module 140, in one embodiment, supervises the AI program locally within the system of the AI program. In either case, in addition to supervising the AI program, the watchdog module 140 also activates the control binary 160 to halt the execution of the AI program as will be discussed in greater detail subsequently with method 300.

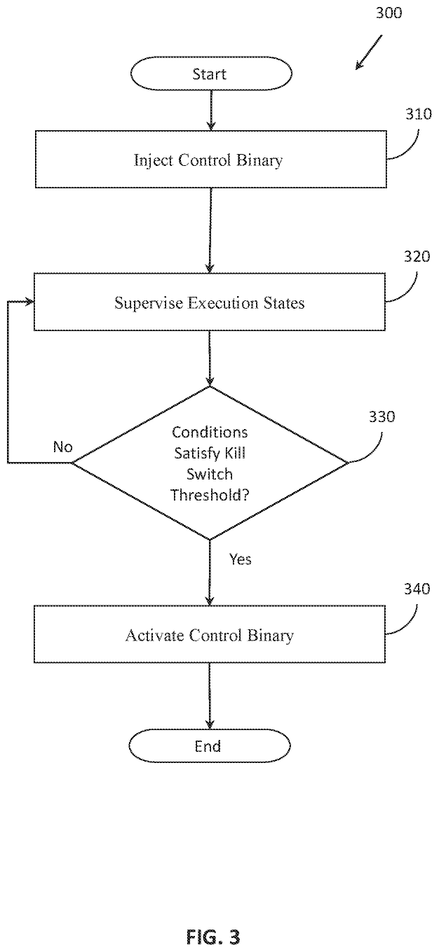

FIG. 3 illustrates a method 300 associated with managing execution of an artificial intelligence (AI) program. Method 300 will be discussed from the perspective of the supervisory control system 100 of FIG. 1. While method 300 is discussed in combination with the supervisory control system 100, it should be appreciated that the method 300 is not limited to being implemented within the supervisory control system 100 but is instead one example of a system that may implement the method 300.

At 310, the execution module 130 injects the control binary 160 into the AI program. In one embodiment, the execution module 130 injects the control binary 160 into embedded device firmware that executes the AI program. For example, the execution module 130 accesses the firmware and stores the control binary 160 among code of the AI program such that the control binary 160 is integrated with the AI program and in a manner that provides access by the control binary 160 to aspects of the AI program. One characteristic of injecting the control binary 160 in the noted manner is to provide for security privileges attributed to instructions of the control binary 160 because of the integration with the AI program. That is, supervisory processes of the system, of the AI program itself, or as provided for otherwise may view the control binary 160 as a native process because the control binary 160 is integrated into the firmware. Consequently, injecting the control binary 160 in the noted manner can avoid security mechanisms that may otherwise prevent external processes from interacting with memory, data structures, and other aspects related to the AI program.

Moreover, memory/firmware that stores the AI program and the control binary 160 upon being injected is, in one embodiment, integrated with an electronic control unit (ECU) or other processing unit to execute the AI program. It should be appreciated that the particular configuration of firmware and executing device(s) may vary according to various implementations; however, various configurations can include ECUs within a vehicle and associated embedded memories, and so on.

At 320, the watchdog module 140 supervises the AI program to identify execution states within the AI program. In one embodiment, the watchdog module 140 monitors inputs, intermediate/internal values, output values (e.g., predictions that are control outputs generated by the AI program resulting from the AI program processing one or more sensor inputs), internal data structures storing learned characterizations of perceptions, and so on. As previously specified, the watchdog module 140 may monitor the noted values according to defined possible ranges for the values, previously identified combinations corresponding to adverse operating conditions, and so on.

That is, the watchdog module 140 defines a range of expected/possible values for the various execution states through, for example, testing of the program, tracking of the program during verified execution, static analysis of the AI program, and so on. In one approach, the watchdog module 140 generates the ranges/conditions over a history of observed values gathered from the monitoring. In either case, the watchdog module 140 acquires the present values defining the present execution states of the AI program at 320 through access into the AI program. That is, in one approach, the watchdog module 140 examines memory locations, execution threads, registers, and/or other sources of information about the AI program to collect the values that define the present execution states. Whichever approach is undertaken to acquire the values, the control binary 160 generally facilitate the access to otherwise guarded/secure aspects of the AI program. Moreover, the watchdog module 140 receives the execution states at a remote device for further analysis to determine when the execution states satisfy a kill switch threshold.

At 330, the watchdog module 140 determines whether the execution states identified at 320 satisfy a kill switch threshold. In one embodiment, the kill switch threshold is the combination of values for the execution states at which the watchdog module 140 triggers the control binary 160. For example, the kill switch threshold defines values for the execution conditions that are indicative of adverse operating conditions. Thus, the kill switch threshold provides a quantitative metric by which to determine when the AI program should be halted. In one embodiment, the kill switch threshold defines the adverse operating conditions according to behaviors of the AI program that violate a standard operating range or indicated functional standard (e.g., ISO 26262).

Thus, the watchdog module 140 compares the kill switch threshold with the identified execution states at 330 to determine whether the execution states satisfy the kill switch threshold and are thus indicative of an adverse operating condition. If the watchdog module 140 determines that the execution states satisfy the threshold (e.g., are outside of a defined range, greater than a prescribed value, less than a particular margin, equal to a defined correlation, etc.), then the watchdog module 140 proceeds to activate the control binary at 340. Otherwise, the watchdog module 140 continues to iteratively acquire updated execution states and check the states in an ongoing manner while the AI program is executing. The frequency with which the watchdog module 140 monitors the AI program may vary according to implementation. However, as a general principle, the watchdog module 140 semi-continuously acquires the updated execution states and checks the execution states at a sufficient frequency so as to catch developments within the AI program that may result in adverse operating conditions. Thus, the watchdog module 140 may check the AI program with a frequency that is comparable to a clock frequency of a processor/control unit on which the AI program is executing.

At 340, the watchdog module 140 activates the control binary 160 to cause the AI program to cease execution. In one embodiment, the watchdog module 140 transmits a control signal from the remote device to the control binary 160 to initiate cessation of the execution. The control binary 160 then, for example, executes a stop function that causes the AI program to cease execution. In one approach, the stop function manipulates the program flow of the Ai program to interrupt execution of the AI program and instead execute, for example, a failover function. In alternative arrangements, the control binary 160 resets an associated device or at least processing unit on which the AI program is executing. In still further embodiments, the control binary 160 resets internal states, memory locations, and/or other aspects of the AI program to clear the execution states that lead to the adverse operating conditions and avoid such execution states in subsequent operation.

Moreover, the activation of the control binary 160, as noted, can further include the execution of failover functions. The failover functions generally include functionality that facilitates the associated device with recovery from the reset/halting of the AI program. Thus, where the AI program is involved in providing functionality to an advanced driving assistance system (ADAS), autonomous driving system, or other vehicular system that may influence the operation of the vehicle, the failover function that is then executed by the control binary 160 can provide for continued safe operation of the vehicle when the AI program is unexpectedly reset while the vehicle is in operation. For example, the failover function may range in functionality from providing a simple warning to a driver to controlling the vehicle to perform a safety maneuver such as safely pulling to the side of the road. In this way, the supervisory control system accounts not only for avoiding the adverse operating conditions of the AI program but also safe operation of the vehicle thereafter.

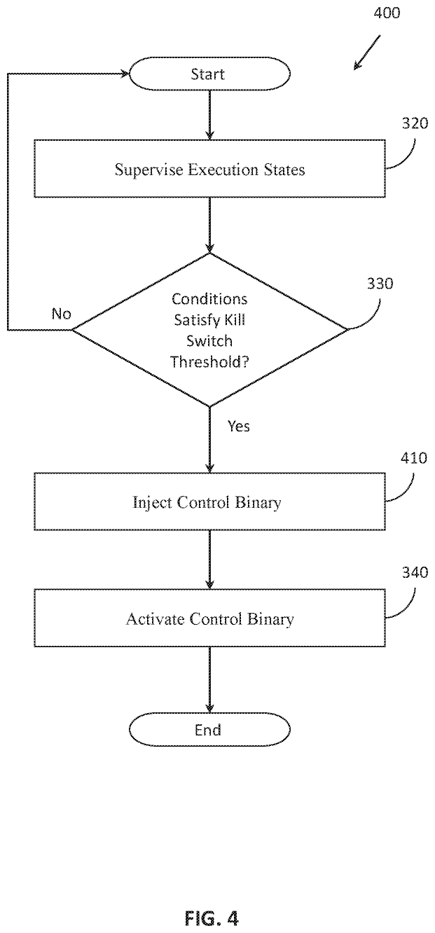

FIG. 4 illustrates a method 400 associated with dynamically injecting a control binary into an AI program. Method 400 will be discussed from the perspective of the supervisory control system 100 of FIG. 1. While method 400 is discussed in combination with the supervisory control system 100, it should be appreciated that the method 400 is not limited to being implemented within the supervisory control system 100 but is instead one example of a system that may implement the method 400.

The method 400 generally parallels the method 300 and thus a detailed description of the shared aspects will not be revisited. However, as a general context, consider that the method 400 provides an alternative to method 300 by leveraging the control binary 160 in a different manner. For example, the execution module 130 does not initially inject the control binary 160 into the AI program but instead uses the control binary 160 in a similar manner as malicious attacks redirect program control flow.

As shown in FIG. 4, the watchdog module 140 supervises the execution states and determines when the execution states satisfy the kill switch threshold. Of course, because the control binary 160 has not been injected into the AI program as of yet, the watchdog module 140 generally leverages other mechanisms to acquire the current execution states. That is, since the control binary 160 is not embedded with the AI program at this point in the method 400, the watchdog module 140 monitors the AI program through other available mechanisms. The alternative approaches to acquiring the execution states may include sniffing inputs and outputs, monitoring power consumption, monitoring electromagnetic emissions, monitoring memory accesses, monitoring processor threads, monitoring registers, and so on. In any case, the information available to the watchdog module 140 may not be as comprehensive in the approach provided by method 400 but generally still acquires sufficient information to manage the AI program.

Thus, instead of activating the control binary 160 upon determining the kill switch threshold has been satisfied, the execution module 130 in operation under method 400, at 410, injects the control binary 160 into the AI program. In one embodiment, the execution module 130 manipulates one or more memory locations to dynamically alter a program control flow of the AI program and thereby redirect execution into instructions of the control binary 160. Thus, the control binary 160 represents a separate control flow path through the manipulation provided by the execution module 130. In either case, once the AI program control flow is adjusted at 410, the control binary 160 is activated at 340 to execute as discussed previously. Accordingly, the method 400 generally represents an alternative to halting execution of the AI program when, for example, the control binary 160 cannot or otherwise is not embedded with the AI program as precondition.

Additionally, it should be appreciated that the supervisory control system 100 from FIG. 1 can be configured in various arrangements with separate integrated circuits and/or chips. In such embodiments, the execution module 130 from FIG. 1 is embodied as a separate integrated circuit. Additionally, the watchdog module 140 is embodied on an individual integrated circuit. The circuits are connected via connection paths to provide for communicating signals between the separate circuits. Of course, while separate integrated circuits are discussed, in various embodiments, the circuits may be integrated into a common integrated circuit board. Additionally, the integrated circuits may be combined into fewer integrated circuits or divided into more integrated circuits. In another embodiment, the modules 130, and 140 may be combined into a separate application-specific integrated circuit. In further embodiments, portions of the functionality associated with the modules 130, and 140 may be embodied as firmware executable by a processor and stored in a non-transitory memory. In still further embodiments, the modules 130, and 140 are integrated as hardware components of the processor 110.

In another embodiment, the described methods and/or their equivalents may be implemented with computer-executable instructions. Thus, in one embodiment, a non-transitory computer-readable medium is configured with stored computer executable instructions that when executed by a machine (e.g., processor, computer, and so on) cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

The supervisory control system 100 can include one or more processors 110. In one or more arrangements, the processor(s) 110 can be a main processor of the supervisory control system 100. For instance, the processor(s) 110 can be an electronic control unit (ECU). The supervisory control system 100 can include one or more data stores for storing one or more types of data. The data stores can include volatile and/or non-volatile memory. Examples of suitable data stores include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, distributed memories, cloud-based memories, other storage medium that are suitable for storing the disclosed data, or any combination thereof. The data stores can be a component of the processor(s) 110, or the data store can be operatively connected to the processor(s) 110 for use thereby. The term “operatively connected,” as used throughout this description, can include direct or indirect connections, including connections without direct physical contact.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Examples of such a computer-readable medium may include, but are not limited to, a floppy disk, a flexible disk, a hard disk, a magnetic tape, other magnetic medium, an ASIC, a graphics processing unit (GPU), a CD, other optical medium, a RAM, a ROM, a memory chip or card, a memory stick, and other media from which a computer, a processor or other electronic device can read. In the context of this document, a computer-readable storage medium may be any tangible medium that can contain, or store a program for use by or in connection with an instruction execution system, apparatus, or device.

The following includes definitions of selected terms employed herein. The definitions include various examples and/or forms of components that fall within the scope of a term, and that may be used for various implementations. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. Module may include a microprocessor controlled by an algorithm, a discrete logic (e.g., ASIC), an analog circuit, a digital circuit, a programmed logic device, a memory device including instructions that when executed perform an algorithm, and so on. A module, in one or more embodiments, includes one or more CMOS gates, combinations of gates, or other circuit components. Where multiple modules are described, one or more embodiments include incorporating the multiple modules into one physical module component. Similarly, where a single module is described, one or more embodiments distribute the single module between multiple physical components.

Additionally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), as a graphics processing unit (GPU), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A supervisory control system for managing execution of an artificial intelligence (AI) program, comprising:
one or more processors; and
a memory communicably coupled to the one or more processors and storing:
a watchdog module including instructions that when executed by the one or more processors cause the one or more processors to:
supervise execution of the AI program to identify execution states associated with the AI program indicative of at least current predictions produced by the AI program, and
activate a control binary to cause the AI program to cease execution when the execution states satisfy a kill switch threshold, wherein the kill switch threshold defines conditions associated with the execution of the AI program indicative of adverse operating conditions.

2. The supervisory control system of claim 1, further comprising:
an execution module including instructions that when executed by the one or more processors cause the one or more processors to inject the control binary into the AI program, wherein the control binary is a portion of executable code that executes to interrupt execution of the AI program.

3. The supervisory control system of claim 2, wherein the execution module includes instructions to inject the control binary including instructions to perform one of: inserting the control binary within the AI program at a randomized location to obfuscate the control binary from detection and dynamically altering a program flow of the AI program by using the control binary to interrupt the AI program.

4. The supervisory control system of claim 1, wherein the watchdog module includes instructions to activate the control binary including instructions to execute a stop function of the control binary that causes the AI program to cease execution, and execute a failover function that causes an associated device to safely recover from halting the AI program from executing.

5. The supervisory control system of claim 1, wherein the watchdog module includes instructions to supervise execution of the AI program including instructions to automatically monitor the AI program by examining memory locations associated with internal states of the AI Program to identify the execution states, and wherein the current predictions include control outputs generated by the AI program resulting from the AI program processing one or more sensor inputs.

6. The supervisory control system of claim 1, wherein the watchdog module includes instructions to supervise execution of the AI program including instructions to receive the execution states at a remote device, and monitor, from the remote device, the execution states to determine when the execution states satisfy the kill switch threshold, and wherein the watchdog module includes instructions to activate the control binary by transmitting a control signal from the remote device.

7. The supervisory control system of claim 1, wherein the AI program is a machine learning algorithm, and wherein the kill switch threshold defines the adverse operating conditions according to behaviors of the AI program that violate a standard operating range.

8. The supervisory control system of claim 1, wherein the AI program is integrated within a vehicle and the supervisory control system is remote from the vehicle.

9. A non-transitory computer-readable medium storing instructions for managing execution of an artificial intelligence (AI) program and that when executed by one or more processors cause the one or more processors to:
supervise execution of the AI program to identify execution states associated with the AI program indicative of at least current predictions produced by the AI program, and
activate a control binary to cause the AI program to cease execution when the execution states satisfy a kill switch threshold, wherein the kill switch threshold defines conditions associated with the execution of the AI program indicative of adverse operating conditions.

10. The non-transitory computer-readable medium of claim 9, further including instructions to:
inject the control binary into the AI program, wherein the control binary is a portion of executable code that executes to interrupt execution of the AI program.

11. The non-transitory computer-readable medium of claim 9, wherein the instructions to activate the control binary include instructions to execute a stop function of the control binary that causes the AI program to cease execution, and execute a failover function that causes an associated device to safely recover from halting the AI program from executing.

12. The non-transitory computer-readable medium of claim 9, wherein the instructions to supervise execution of the AI program include instructions to automatically monitor the AI program by examining memory locations associated with internal states of the AI Program to identify the execution states, and
wherein the current predictions include control outputs generated by the AI program resulting from the AI program processing one or more sensor inputs.

13. The non-transitory computer-readable medium of claim 9, wherein the instructions to supervise execution of the AI program include instructions to receive the execution states at a remote device, and monitor, from the remote device, the execution states to determine when the execution states satisfy the kill switch threshold, and
wherein the instructions to activate the control binary include instructions to transmit a control signal from the remote device to cause the control binary to execute.

14. A method for managing execution of an artificial intelligence (AI) program, comprising:
supervising execution of the AI program to identify execution states associated with the AI program indicative of at least current predictions produced by the AI program; and
activating a control binary to cause the AI program to cease execution when the execution states satisfy a kill switch threshold, wherein the kill switch threshold defines conditions associated with the execution of the AI program indicative of adverse operating conditions.

15. The method of claim 14, further comprising:
injecting the control binary into the AI program, wherein the control binary is a portion of executable code that interrupts execution of the AI program.

16. The method of claim 15, wherein injecting the control binary includes one of: inserting the control binary within the AI program at a randomized location to obfuscate the control binary from detection and dynamically altering a program flow of the AI program by using the control binary to interrupt the AI program.

17. The method of claim 14, wherein activating the control binary includes executing a stop function of the control binary that causes the AI program to cease execution, and executing a failover function that causes an associated device to safely recover from halting the AI program from executing.

18. The method of claim 14, wherein supervising execution of the AI program includes automatically monitoring the AI program by examining memory locations associated with internal states of the AI Program to identify the execution states, and wherein the current predictions include control outputs generated by the AI program resulting from the AI program processing one or more sensor inputs.

19. The method of claim 14, wherein supervising execution of the AI program includes receiving the execution states at a remote device, and monitoring, from the remote device, the execution states to determine when the execution states satisfy the kill switch threshold, and wherein activating the control binary occurs in response to a control signal transmitted from the remote device.

20. The method of claim 14, wherein the AI program is a machine learning algorithm, wherein the kill switch threshold defines the adverse operating conditions according to behaviors of the AI program that violates a standard operating range.
